(19) United States
(12) Patent Application Publication
(10) Pub. No.: US 2013/0058406 A1
(43) Pub. Date: Mar. 7, 2013

(54) PREDICTIVE FRAME DROPPING METHOD USED IN WIRELESS VIDEO/AUDIO DATA TRANSMISSION

(71) Applicants: Zhou Ye, Foster City, CA (US); Tsung-Yu Chen, Taipei City (TW)

(72) Inventors: Zhou Ye, Foster City, CA (US); Tsung-Yu Chen, Taipei City (TW)

(21) Appl. No.: 13/299,323

(22) Filed: Nov. 17, 2011

Related U.S. Application Data
(63) Continuation-in-part of application No. 13/225,485, filed on Sep. 5, 2011.

(51) Int. Cl. H04N 7/32

(52) U.S. Cl. 375/240.12; 375/E07.243

(57) ABSTRACT

A predictive frame dropping method used in wireless video/audio data transmission using a video decoder or a video encoder under compressed domain instead of raw domain is provided. The method drops at least one consecutive P-frame directly in front of each I-frame sequentially in each group of pictures (GOP) for reducing the total amount of cache memory required for frame buffering and avoiding the memory from overflowing either before the data are being decompressed by the video decoder at the receiver side or after being compressed by the video encoder at the transmitter side. A controller for controlling the quantity of number of P-frames to be dropped is provided. The video decoder does not need any off-chip DDR memory. An SRAM can reside in either the video decoder or the video encoder for carrying out the predictive frame dropping method.

### CROSS-REFERENCE TO RELATED APPLICATIONS

This application is a continuation-in-part of an U.S. patent application, titled “WIRELESS VIDEO/AUDIO DATA TRANSMISSION SYSTEM” with U.S. application Ser. No. 13/225,485, which is filed on Sep. 5, 2011, now pending, and this application having at least one inventor in common, namely, Zhou Ye. The contents of the above-mentioned patent application is hereby incorporated by reference herein in its entirety and made a part of this specification.

### BACKGROUND OF THE INVENTION

1. Technical Field

The present invention relates to a video compression technique for video/audio data transmission using a video decoder having a SRAM memory. More particularly, this invention relates to a predictive frame dropping method used in wireless video/audio data transmission using a video decoder having a SRAM memory.

2. Description of Related Art

In MPEG video compression, a group of pictures (GOP) contains at least two frame types, including: I-frame (intra coded picture), which represents a fixed image and is independent of other picture frames in the sequence. Each GOP begins with an I frame, and P-frame (predictive coded picture) contains motion-compensated difference information from the preceding I-frame or P-frame, which means that each one P-frame has a dependency on the preceding I-frame or P-frame. A GOP always begins with an I-frame. Afterwards several P-frames follow, in each case with some frames distance. Some video codecs allow for more than one I-frame in a GOP. The I-frames contain the full image and do not require any additional information to reconstruct itself. Therefore, any errors within the GOP structure are corrected by the next I-frame. The more I-frames the video stream has in possession, the more editable the video stream becomes. However, having more I-frames increases the stream size correspondingly. Therefore, for the sake of conserving bandwidth and disk space, typically videos designed for internet broadcast often have only one I-frame per GOP. The distance between two adjacent full images (i.e., two adjacent I-frames) is called the GOP length. I-frame is also known as reference or key frames, which contain all the necessary frame data to re-create a complete image. I-frames are the largest type of MPEG frame, but they are faster to decompress than other types of MPEG frames. Meanwhile, P-frames are typically much smaller than I-frames.

In the conventional video decoder, such as H.264/AVC video decoder, for example, the cache memory for frame buffering is usually provided in the fond of an off-chip external DDR memory. Therefore, DDR memory adds cost and integrated circuit footprint. Typically, only fully-processed or decoded pixel data are stored in the DDR, instead of storing frame data in the compressed domain. Video playback is typically at 30 frames per second and at 720p or 1080p. Because the frame buffer of the DDR has a limited memory, thus, only a small number of video frames can be stored inside the DDR memory, typically the DDR stores up to 3 frames of 720p quality images.

After the video decoder has decoded the raw data, the RGB file in the raw domain then proceeds on to perform frame dropping of the raw data. Therefore, the problems faced by conventional video decoding are of having excessive frame size and thereby adding cost and overhead to the overall video compression. In a conventional video/audio transmission system, when the reference frequency for both the video encoder and decoder are being set at 27 MHz, for example, the respective system clocks are oscillating at above +/−30 ppm tolerance, and the output images at the display end out of the video decoder would thereby experience defective or poor image quality. Therefore, there is room for improvement in the art. Meanwhile, conventional video decoding is performed using an off-chip DDR memory working along the video decoder, therefore, there is no need to perform any dropping frame in compressed domain in the DDR.

### SUMMARY OF THE INVENTION

One aspect of the invention is to provide a predictive frame dropping method used in wireless video/audio data transmission when using a video decoder having a SRAM memory under compressed domain instead of raw domain.

Another aspect of the invention is to provide a predictive frame dropping method used in wired video/audio data transmission when using a video encoder having a SRAM memory under compressed domain instead of raw domain.

Another aspect of the invention is to provide a predictive frame dropping method by dropping at least one P-frame directly in front of each I-frame in compressed stream domain before being decompressed by the video decoder at the receiver side.

Another aspect of the invention is to provide a predictive frame dropping method by dropping at least one P-frame directly in front of each I-frame in compressed stream domain after being compressed by the encoder at the transmitter side.

Another aspect of the invention is to provide a predictive frame dropping method by dropping at least one consecutive P-frames directly in front of each I-frame in each group of picture to avoid the SRAM of the video decoder from overflowing.

To achieve the foregoing and other aspects, a controller for controlling the quantity of number of P-frames to be dropped is provided.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is a flow chart showing a predictive frame dropping method used in wireless video/audio data transmission and a video/audio data transmission apparatus for processing frame images under compressed domain at the video decoder according to a first embodiment of present application.

FIG. 2 is a flow chart showing a predictive frame dropping method used in wireless video/audio data transmission and a video/audio data transmission apparatus for processing frame images under compressed domain at the video encoder according to a second embodiment of present application.

FIG. 3 is a flow chart illustrating the predictive frame dropping method of the first embodiment being used in a more specific detailed example.

### DETAILED DESCRIPTION OF THE INVENTION

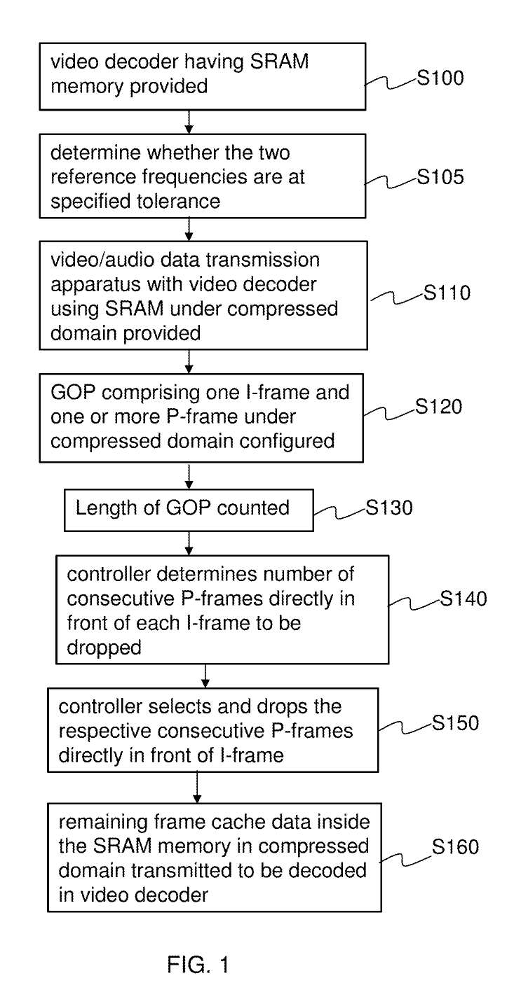

Referring to FIG. 1, as shown in a first embodiment of instant application, a predictive frame dropping method used in wireless video/audio data transmission is shown. In step S100, a video decoder, for example, having a SRAM memory, at a receiver side and a video encoder at a transmitter side are provided. In step S105, a first reference frequency at the video encoder and a second reference frequency at the decoder are determined as to whether the two reference frequencies are within a specified tolerance. In step S110, a video/audio data transmission apparatus for processing pixel data or frame images at the video decoder using the on-chip SRAM memory under compressed domain is provided. The data in compressed domain in the SRAM memory is about 100 times smaller in size than the typical video buffer cache data stored in DDR under raw domain. In step S120, a group of pictures (GOP) comprising I-frame and P-frame under compressed domain is configured. In step S130, the length of a group of pictures is counted. In step S140, a controller at the video decoder determines a predetermined amount of consecutive P-frames that are positioned directly in front of each I-frame to be dropped. In step S150, the controller selects the respective consecutive P-frames that are directly in front of each I-frame to be dropped, thereby dropping the predetermined number of consecutive P-frames in front of one I-frame before the data is decompressed by the video decoder. In step S160 the controller transmits all remaining frame cache data inside the SRAM memory in compressed domain to be decoded in the video decoder at the receiver side.

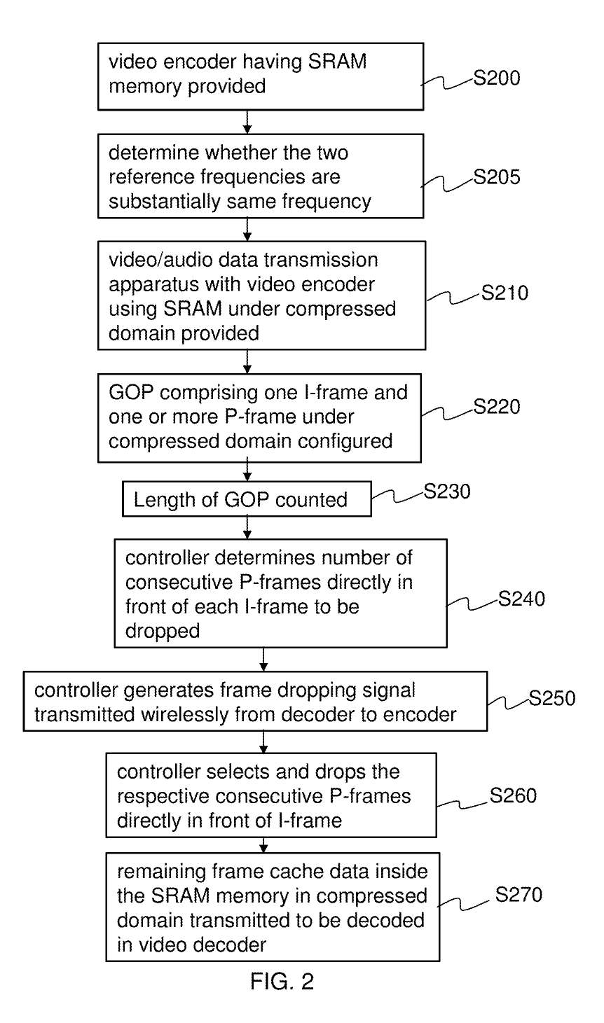

Referring to FIG. 2, in a second embodiment of instant application, a predictive frame dropping method used in wireless video/audio data transmission is shown. In step S200, a video encoder having a SRAM memory is provided. The video encoder is at a transmitter side. In step S205, a first reference frequency at the video encoder and a second reference frequency at the video decoder are determined as to whether the two reference frequencies are substantially the same frequency. In step S210, a video/audio data transmission apparatus for processing pixel data or frame images at the video encoder using the on-chip SRAM memory under compressed domain is provided. The data in compressed domain in the SRAM memory is about 100 times smaller in size than the typical video buffer cache data stored in DDR under raw domain. In step S220, a group of pictures (GOP) comprising I-frame and P-frame under compressed domain is configured. In step S230, the length of a group of pictures is counted. In step S240, a controller at the video decoder determines the predetermined amount of consecutive P-frames that are positioned directly in front of each I-frame to be dropped based previous human visual detection testing results prior to data decoding or data decompressing in the video decoder at the receiver side. In step S250, the controller generates a frame dropping signal to be transmitted wirelessly from the video decoder at the receiver side to the video encoder at the transmitter side. In step S260, the controller selects the respective consecutive P-frames that are directly in front of each I-frame to be dropped after data compression at the video encoder, thereby dropping a predetermined number of consecutive P-frames in front of one I-frame in the SRAM memory after data compression at the video encoder. In step S270, the controller transmits all remaining frame cache data inside the SRAM memory in compressed domain from the video encoder in the transmitter wirelessly to the video decoder in the receiver.

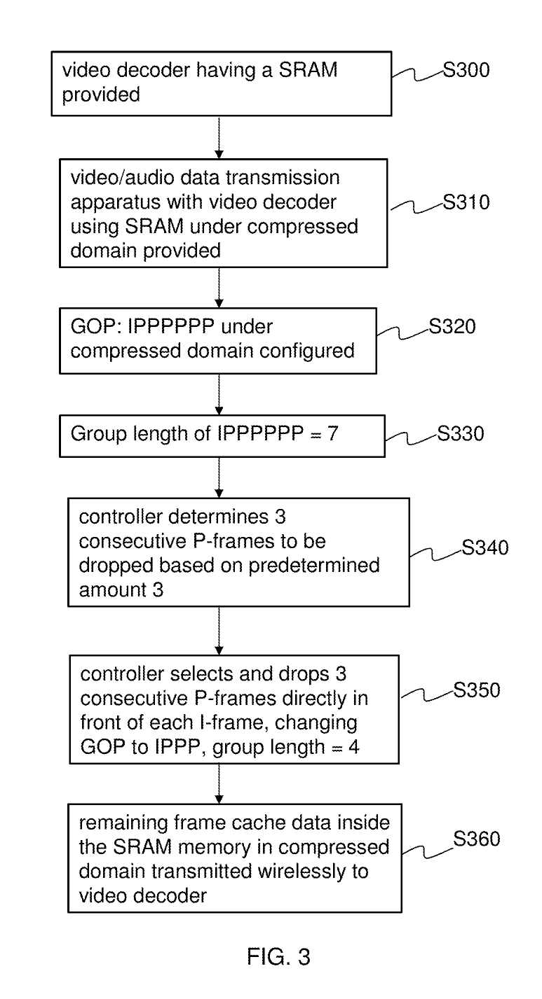

In a third embodiment, referring to FIG. 3, similar to the first embodiment of instant application, the predictive frame dropping method used in wireless video/audio data transmission is shown in another example. Steps S300, S305 and S310 are the same as S100, S105 and S110, respectively. In step S320, a group of pictures (GOP) including IPPPPPP under compressed domain is configured. In step S330, the group length of IPPPPPP . . . is equal to 7. In step S340, a controller at the video decoder determines that there are 6 consecutive P-frames that are positioned directly in front of each I-frame, and that the predetermined amount of consecutive P-frames to be dropped is 3. In step S350, a controller selects the respective three consecutive P-frames that are directly in front of each I-frame to be dropped, thereby dropping the three consecutive P-frames in front of the I-frame and changing the group of pictures to IPPP and the group length to be 4, by dropping the three P-frames directly next to the first I-frame of the next group of pictures (first I-frame subsequent to the above group of picture, i.e. IPPPPPP IPPPPPP IPPPPPP . . . , with three groups of pictures shown). In step S360, the controller transmits all remaining frame cache data inside the SRAM memory in compressed domain to be decoded or decompressed in the video decoder. In alternative embodiments, the predetermined amount of total number of consecutive P-frames to be dropped can be, for example, 1, 2, 4, 5 . . . etc, and the group length can be, for example, 4, 10, 20, 30, etc. . . .

In a fourth embodiment, the predictive frame dropping method can be adapted for use in a wired video/audio data transmission system in which the frame dropping signal generated by the controller can be transmitted in a wired manner from the video decoder to the video encoder, and all video/audio data streams are transmitted also in a wired manner from the video encoder to the video decoder. In the above embodiments, the video decoder can provide video playback at 30 or 60 frames per second at 720p or 1080p, for example.

It is to be further understood that, because the predictive frame dropping method depicted in the accompanying drawings are preferably implemented in software, the actual connections between the process function blocks may differ depending upon the manner in which the present invention is programmed. Given the teachings herein, one of ordinary skill in the pertinent art will be able to contemplate these and similar implementations or configurations of the present invention.

Although the illustrative embodiments have been described herein with reference to the accompanying drawings, it is to be understood that the present invention is not limited to those precise embodiments, and that various changes and modifications may be effected therein by one of ordinary skill in the pertinent art without departing from the scope or spirit of the present invention. All such changes and modifications are intended to be included within the scope of the present invention as set forth in the appended claims.

What is claimed is:

1. A predictive frame dropping method used in wireless video/audio data transmission, the method comprising the steps of:
providing a video decoder at a receiver, and providing a video encoder at a transmitter;
determining whether a first reference frequency at the video encoder is substantially the same as a second reference frequency at the video decoder;
providing a video/audio data transmission apparatus for processing frame images under compressed domain before decompressing the data at the video decoder;
configuring a group of pictures comprising one I-frame and at least one P-frame under compressed domain;
counting the length of the group of pictures;
determining a predetermined amount of consecutive P-frames that are positioned directly in front of each I-frame to be dropped; and
selecting and dropping the predetermined amount of consecutive P-frames directly in front of each I-frame.

2. The method as claimed in claim 1, further comprising the step of:
transmitting all remaining frame cache data in compressed domain to be decoded in the video decoder.

3. The method as claimed in claim 1, wherein the predetermined amount of consecutive P-frame is one.

4. The method as claimed in claim 1, wherein the video decoder does not have a DDR memory.

5. The method as claimed in claim 1, wherein the remaining frame cache data in compressed domain is stored in a SRAM, and the SRAM is an on-chip internal SRAM memory acting as the frame buffer.

6. The method as claimed in claim 1, wherein the I-frames and the P-frames are stored in only compressed domain at the receiver.

7. The method as claimed in claim 1, wherein the video decoder provides video playback at 30 or 60 frames per second at 720p or 1080p.

8. A predictive frame dropping method used in wireless video/audio data transmission, the method comprising the steps of:
providing a video encoder and a video decoder;
determining whether a first reference frequency at the video encoder is substantially the same as a second reference frequency at the video decoder;
providing a video/audio data transmission apparatus for processing frame images under compressed domain after data compression at the video encoder;
configuring a group of pictures comprising one I-frame and at least one P-frame under compressed domain;
counting the length of the group of pictures;
determining a predetermined amount of consecutive P-frames that are positioned directly in front of each I-frame to be dropped;
generating and transmitting a frame dropping signal from the video decoder to the video encoder; and
selecting and dropping the predetermined amount of consecutive P-frames directly in front of each I-frame.

9. The method as claimed in claim 8, further comprising the step of:
transmitting all remaining frame cache data in compressed domain from the video encoder wirelessly to the video decoder.

10. The method as claimed in claim 8, wherein the predetermined amount of consecutive P-frame is one.

11. The method as claimed in claim 9, wherein the remaining frame cache data in compressed domain is stored in a SRAM, and the SRAM is an on-chip internal SRAM memory acting as the frame buffer in the video decoder.

12. The method as claimed in claim 9, wherein the I-frames and the P-frames are stored in only compressed domain at the transmitter.

13. The method as claimed in claim 8, wherein the video decoder provides video playback at 30 or 60 frames per second at 720p or 1080p.

14. The method as claimed in claim 8, wherein the video decoder does not have a DDR memory.

15. A predictive frame dropping method used in wireless video/audio data transmission, the method comprising the steps of:
providing a video decoder at a receiver, and providing a video encoder at a transmitter, wherein the video decoder has a SRAM memory;
determining whether a reference frequency is substantially the same at the video encoder and at the video decoder;
providing a video/audio data transmission apparatus for processing frame images under compressed domain before decompressing at the video decoder;
configuring a group of pictures comprising one I-frame and at least one P-frame under compressed domain;
counting the length of the group of pictures;
determining a predetermined amount of consecutive P-frames that are positioned directly in front of each I-frame to be dropped; and
selecting and dropping the predetermined amount of consecutive P-frames directly in front of each I-frame.

16. The method as claimed in claim 15, further comprising the step of:
transmitting all remaining frame cache data in compressed domain to be decoded in the video decoder at the receiver.
